(19) United States
(12) Patent Application Publication
(10) Pub. No.: US 2018/0276656 A1
(43) Pub. Date: Sep. 27, 2018

(54) INSTANT ISSUANCE OF VIRTUAL PAYMENT ACCOUNT CARD TO DIGITAL WALLET

(71) Applicant: MasterCard International Incorporated, Purchase, NY (US)

(72) Inventors: Akshita Goyal, Jersey City, NJ (US); Manash Bhattacharjee, Jersey City, NJ (US); Silvana Hernandez Duarte, New York, NY (US)

(21) Appl. No.: 15/468,797

(22) Filed: Mar. 24, 2017

(51) Int. Cl. G06Q 20/36; G06Q 20/34; G06Q 20/32; G06Q 20/20

(52) U.S. Cl. CPC G06Q 20/367; G06Q 20/351; G06Q 20/341; G06Q 20/204; G06Q 20/206; G06Q 20/3223

(57) ABSTRACT

An application for a payment card account is received from a consumer. A positive determination is made on the application. In response to the positive determination, a virtual payment card account is made instantly available for use by the consumer in a digital wallet accessible to the consumer.

### BACKGROUND

Payment card accounts are in widespread use. Payment cards and/or associated payment account numbers or payment tokens are frequently presented by consumers and businesses to pay for in-store purchase transactions, online shopping transactions, bill payments and other purposes.

A typical consumer may be issued a payment card account as a result of an application process. Applications for payment card accounts may be taken, for example, online (via a website hosted by the account issuer) or at a branch office (bank branch) maintained by the account issuer.

There exists a disadvantageous aspect of the typical process by which a payment account application is fulfilled after approval of the application. The disadvantage lies in the typical delay of, say, five business days or more between the time the payment card account application is approved and the corresponding physical payment account card is issued and mailed to the (new) account holder. Even though approval may be virtually instantaneous upon receipt of the payment card account application, a number of days, or even a week or two, may pass before the account holder receives the physical card and is able to start using the newly issued payment card account. This gap in time may be inconvenient for the account holder; it may also represent a lost business opportunity for the issuer, since no transactions to the account may take place during that gap in time.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system in which aspects of the present disclosure may be applied.

FIGS. 3 and 4 are block diagrams that illustrate various aspects of payment systems provided according to teachings of the present disclosure.

FIGS. 5 and 6 are block diagrams that illustrate computer systems that may perform roles in one or more of the payment systems illustrated in FIGS. 3 and 4.

FIG. 7 is a block diagram that shows some features of a typical mobile device that may perform a role in one or more of the payment systems illustrated in FIGS. 3 and 4.

FIGS. 8, 9 and 10 are flow charts that illustrate processes that may be performed in accordance with aspects of the present disclosure.

### DETAILED DESCRIPTION

In general, and to introduce concepts of embodiments of this disclosure, a virtual payment account card may be issued instantaneously to a consumer upon approval of the consumer's application for a payment card account. The virtual payment account card issuance may be implemented by provisioning a payment token to or for access by the consumer's payment-enabled mobile device wallet application; alternatively the issuance may be implemented by provisioning of the payment token to a wallet service provider (WSP) that maintains the consumer's digital wallet. The payment card account application may be submitted via the consumer's WSP or directly to the account issuer.

With instant issuance of the virtual payment account card, the account holder may begin engaging in transactions using the corresponding payment account immediately via the account holder's digital wallet, either through his/her WSP or by using wallet functions on his/her payment-enabled mobile device.

Issuance of the corresponding physical payment account card may take place a number of days after approval of the application, in accordance with typical account issuance practices.

In the current discussion, the terms “user”, “consumer” and “account holder” will be used interchangeably.

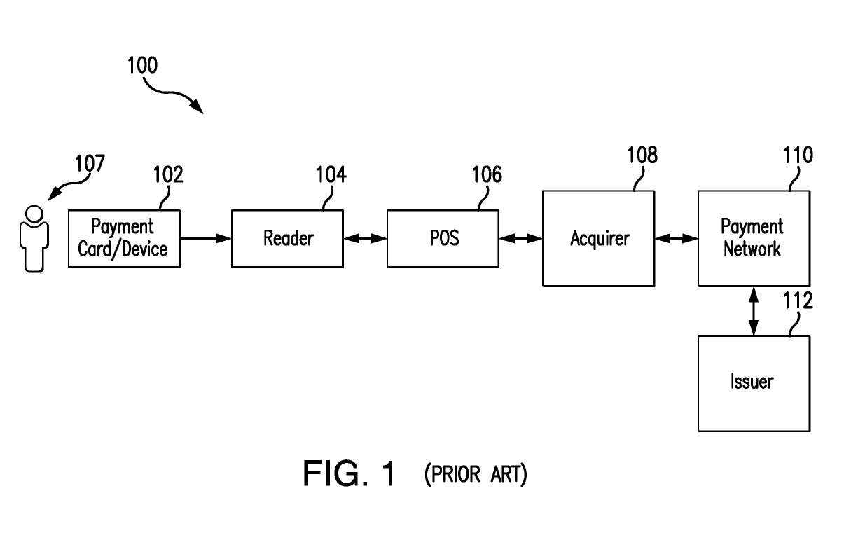

FIG. 1 is a block diagram that illustrates a conventional payment system 100 that may be considered the operating environment and background in which aspects of the present disclosure may be deployed.

The system 100 includes a conventional payment card/device 102 (which may alternatively be, for example, a payment IC card or a payment-enabled mobile device that stores a payment card account number or payment token and runs a payment app). The system 100 further includes a reader component 104 associated with a POS terminal 106. In some known manner (depending on the type of the payment card/device 102) the reader component 104 is capable of reading the payment card account number/token and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction. Reference numeral 107 indicates a user/account holder who is a customer at the retail store and who has presented the payment card/device 102 to the reader component in order to settle the retail transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number or token to the reader component of a POS terminal.

As is also well known, payment account numbers and/or payment tokens may also be employed in online shopping transactions. In such transactions, the user/customer may interact with a shopping website hosted by the merchant's e-commerce server computer (not shown). For such transactions, the merchant's e-commerce server computer may perform many of the functions ascribed above to the POS terminal 106. Such functions may include initiating a payment transaction authorization request message and receiving back a payment transaction authorization response message.

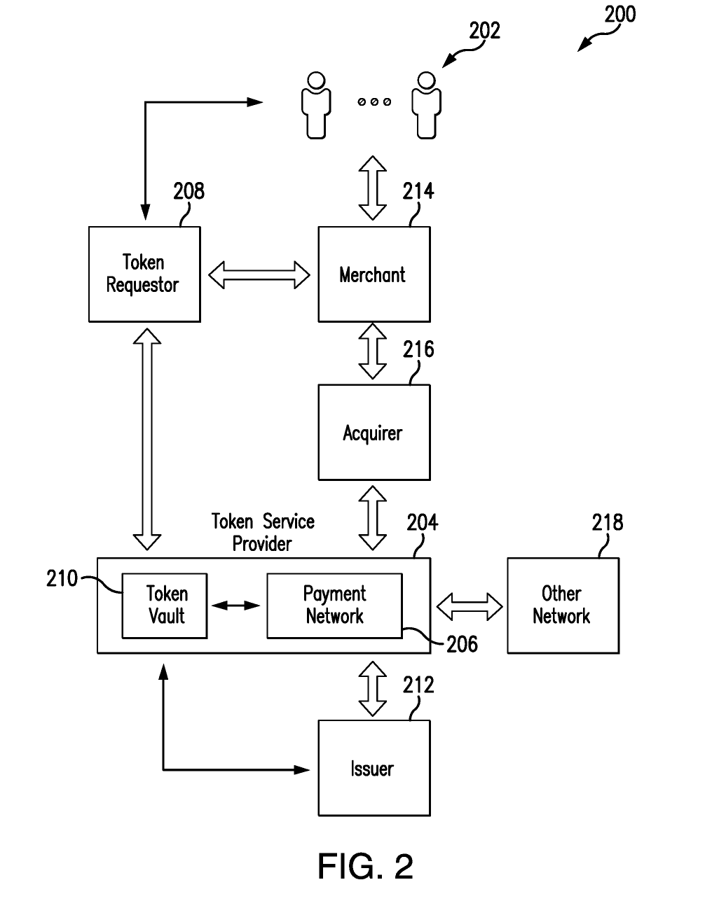

FIG. 2 is a block diagram that illustrates a system 200 in which teachings of the present disclosure may be applied. (FIG. 2 is adapted from the “Figure 1” presented on page 10 of the Payment Token Interoperability Standard (issued by MasterCard International Incorporated (the assignee hereof), Visa and American Express in November 2013). Reference is also made to the EMV® Payment Tokenisation Specification, published March 2014, and available for downloading from www.emvco.com. Payment tokens have been defined as “surrogate values that replace [PANs]” in part of a payment system. “PAN” is the well-known acronym that means “primary account number”.

Individual users/cardholders are indicated by reference numeral 202 in FIG. 2. As is familiar to the reader, the vast majority of the users 202 may habitually carry with them mobile devices such as smartphones, tablet computers, or the like. (To simplify the drawing, these devices are not explicitly shown.) It is assumed that many of the mobile devices may be provisioned with respective payment tokens, in accordance with at least one use case described in the Payment Token Interoperability Standard.

FIG. 2 also includes a block 204 that represents a token service provider. The token service provider 204 may in some embodiments also be the operator of a payment network (block 206), such as the well-known Banknet® system operated by Mastercard International Incorporated, the assignee hereof. The token service provider 204 may be authorized in the system 200 to issue tokens. The payment tokens may be issued to token requestors such as the token requestor represented by block 208 in FIG. 2. (As set forth in the Payment Token Interoperability Standard, token requestors may, for example, include payment card account issuers; card-on-file merchants; acquirers, acquirer-processors, etc.; OEM device manufacturers; and WSPs). Each token requestor 208 may be required to register with the token service provider 204.

In issuing tokens, the token service provider 204 may perform such functions as operating and maintaining a token vault 210, generating and issuing payment tokens, assuring security and proper controls, token provisioning (e.g., provisioning NFC-capable mobile devices with token values; personalizing payment cards with token values), and registering token requestors.

In addition to representing the token service provider, block 204 should also be understood to represent one or more computer systems operated by the token service provider.

Block 212 in FIG. 2 represents an issuer of payment card accounts held by the cardholders 202. Those who are skilled in the art will understand that the issuer is typically a bank or other financial institution, and may provide banking services to the cardholders 202 in addition to issuing payment card accounts (e.g., credit card accounts, debit card accounts) to the cardholders 202. It was noted above that issuers 212 may also have the role of token requestor (block 208) in the system 200.

Block 214 in FIG. 2 represents a merchant to which the cardholders 202 may present payment devices (payment cards and/or payment-enabled mobile devices—e.g., NFC-enabled and token-provisioned mobile devices, etc., none of which are shown in the drawing) to consummate a purchase transaction. In some cases the merchant 214 may also be a token requestor 208 (e.g., for implementing a tokenized card-on-file arrangement for e-commerce transactions with a cardholder 202). According to previously proposed use cases, the merchant may receive a token value from a cardholder's payment device and issue an authorization request to initiate processing of a payment transaction in the system 200.

Block 216 in FIG. 2 represents an acquirer. As is well known, the acquirer may be a financial institution that provides banking services to the merchant 214, and that receives and routes payment transaction authorization requests originated from the merchant 214.

Also shown in FIG. 2 is a block 218, representing another payment network with which the token service provider 204 may interact.

It will be readily appreciated that a practical embodiment of the system 200 may include numerous merchants, token requestors, acquirers and issuers, rather than one of each as depicted in FIG. 2. It may also be the case that there is more than one token service provider in the system.

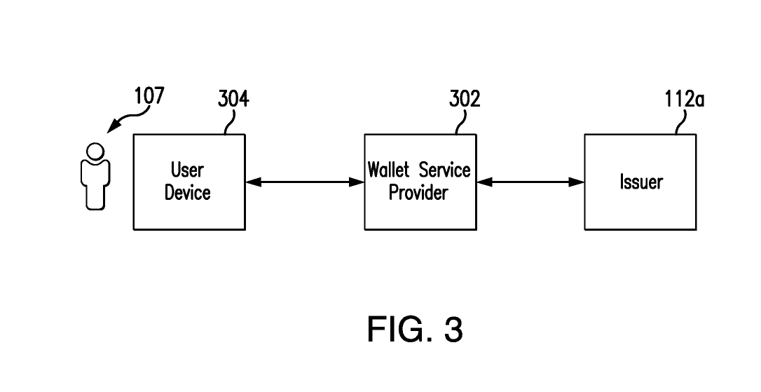

FIG. 3 is a block diagram that illustrates certain aspects of a payment system that may be provided according to teachings of the present disclosure and that may incorporate some or all of the elements of the payment systems illustrated in FIGS. 1 and 2.

Among the payment system components shown in FIG. 3 are a WSP 302, an issuer computer 112a, and a user device 304. The WSP 302 is shown as being in communication with the issuer computer 112a. The WSP 302 is also shown as being in communication with the user device 304.

The user device 304 is associated with/in the possession of the user 107. In various embodiments, the user device 304 may be a mobile device (e.g., a smartphone), a laptop or notebook computer or a personal computer.

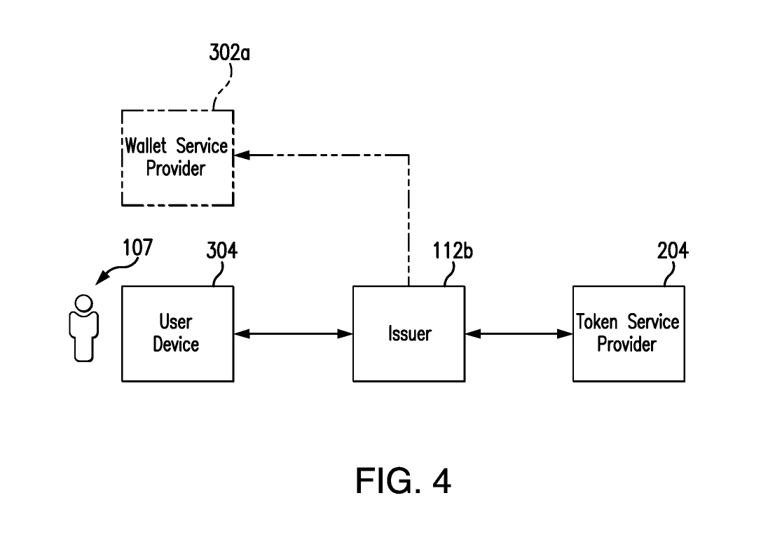

FIG. 4 is a block diagram that illustrates certain aspects of a payment system that may be provided according to teachings of the present disclosure and that may incorporate some or all of the elements of the payment systems illustrated in FIGS. 1 and 2.

As in FIG. 3, the user device 302 and the user 107 are shown in FIG. 4. Other components shown in FIG. 4 include an issuer computer 112b and a token service provider 204. The issuer computer 112b is shown as being in communication with the token service provider 204. The issuer computer 112b is also shown as being in communication with the user device 304. Also, optionally, in some embodiments or in some situations, the issuer computer 112b may be in communication with a WSP 302a (shown in phantom).

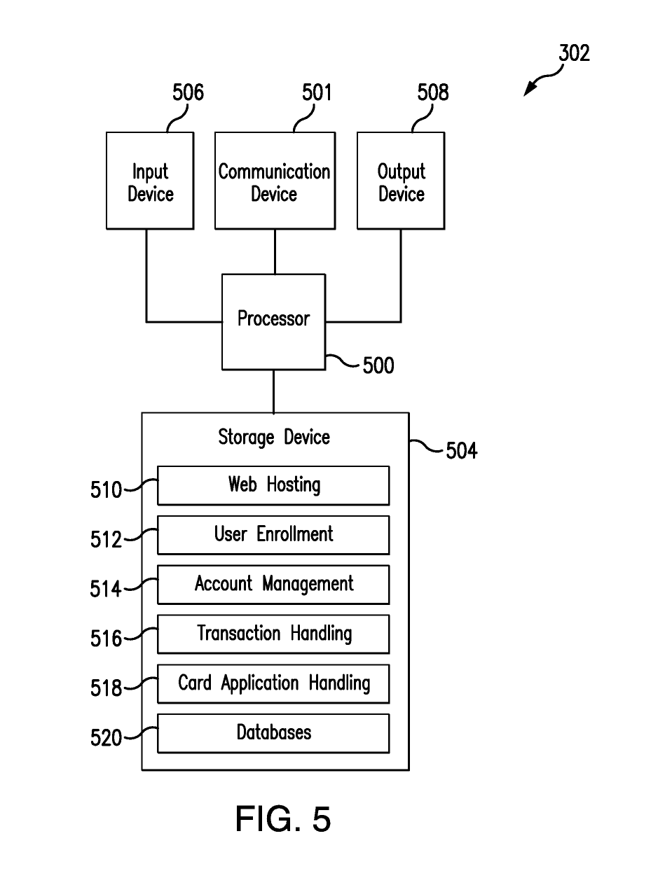

FIG. 5 is a block diagram representation of an embodiment of a computer operated by the WSP 302; the computer illustrated in FIG. 5 will also be indicated by reference numeral 302 and will be referred to as the “WSP computer”. The WSP computer 302 may be constituted by server computer and/or mainframe computer hardware.

The WSP computer 302 may include a computer processor 500 operatively coupled to a communication device 501, a storage device 504, an input device 506 and an output device 508. The computer processor 500 may be in communication with the communication device 501, the storage device 504, the input device 506 and the output device 508.

The computer processor 500 may be constituted by one or more processors. Processor 500 operates to execute processor-executable steps, contained in program instructions described below, so as to control the WSP computer 302 to provide desired functionality.

Communication device 501 may be used to facilitate communication with, for example, other devices (such as devices operated by account holders, account issuers, etc.). For example communication device 501 may comprise numerous communication ports (not separately shown), to allow the WSP computer 302 to communicate simultaneously with a large number of other devices and computers, including communications as required to receive and forward numerous applications for payment cards, in addition to handling numerous payment transactions in accordance with typical functionality of a WSP.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the WSP computer 302, executed by the processor 500 to cause the WSP computer 302 to function as described herein.

The programs stored by the storage device 504 may include one or more operating systems (not shown) that control the processor 500 so as to manage and coordinate activities and sharing of resources in the WSP computer 302, and to serve as a host for application programs that run on the WSP computer 302.

The storage device 504 may also store a web hosting application program 510 that programs the processor 500 to enable the WSP computer 302 to host a website whereby consumers served by the WSP may access and interact with the WSP computer 302.

The storage device 504 may further store a user enrollment application program 512. The user enrollment application program 512 may control the processor 500 to enable the WSP computer 302 to add consumers, at their request, as new users of the services provided by the WSP computer 302.

Still further, the storage device 504 may store an account management application program 514. The account management application program 514 may control the processor 500 to enable the WSP computer 302 to establish, update and maintain user's digital wallet accounts provided on the WSP computer 302

Moreover, the storage device 504 may store a transaction handling application program 516. The transaction handling application program 516 may control the processor 500 to enable the WSP computer 302 to handle payment transactions in accordance with functionality typically available from a WSP.

In addition, the storage device 504 may store a card application handling application program 518. The card application handling application program 518 may control the processor 500 to enable the WSP computer 302 to handle applications for new payment card accounts in a manner described herein and in accordance with aspects of the present disclosure.

The storage device 504 may further store database management programs and an internal reporting application (both not separately shown), the latter of which may respond to requests from computer system administrators for reports on the activities performed by the WSP computer 302; the storage device 504 may also store communication software, device drivers, etc.

The storage device 504 may also store one or more databases 520 required for operation of the WSP 302. The databases 520 may include a digital wallet database (not separately shown) that contains dedicated data partitions in which users' digital wallets are respectively stored.

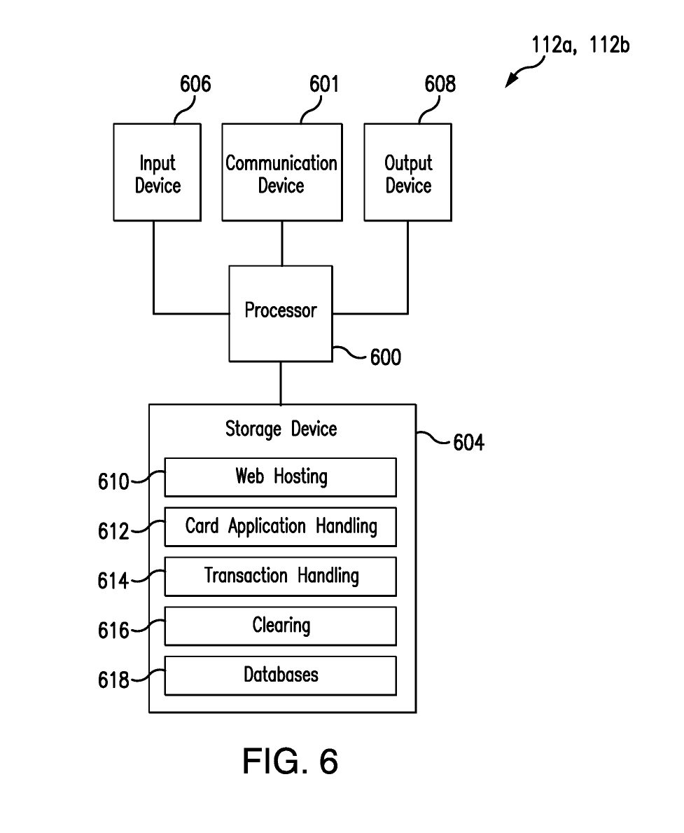

FIG. 6 is a block diagram illustration of an issuer computer 112a or 112b that may be a component of payment systems illustrated in drawings referred to above (for convenience, the computer illustrated in FIG. 6 will be referred to as “issuer computer 112a” in connection with the ensuring description of FIG. 6). The issuer computer 112a may be constituted by server computer and/or mainframe computer hardware.

The issuer computer 112a may include a computer processor 600 operatively coupled to a communication device 601, a storage device 604, an input device 606 and an output device 608. The computer processor 600 may be in communication with the communication device 601, the storage device 604, the input device 606 and the output device 608. The hardware architecture of the issuer computer 112a may resemble that of the WSP computer 302 as described above, and the above description of components of the WSP computer 302 may also apply to like-named components of the issuer computer 112a.

Storage device 604 stores one or more programs for controlling processor 600. The programs comprise program instructions (which may be referred to as computer readable program code means) that contain processor-executable process steps of the issuer computer 112a, executed by the processor 600 to cause the issuer computer 112a to function as described herein.

The programs stored by the storage device 604 may include one or more operating systems (not shown) that control the processor 600 so as to manage and coordinate activities and sharing of resources in the issuer computer 112a, and to serve as a host for application programs that run on the issuer computer 112a.

The storage device 604 may also store a web hosting application program 610 that programs the processor 600 to enable the issuer computer 112a to host a website whereby account holders and/or prospective account holders may access and interact with the issuer computer 112a.

In addition, the storage device 604 may store a card application handling application program 612. The card application handling application program 612 may control the processor 600 to enable the issuer computer 112a to handle applications for new payment card accounts in a manner described herein and in accordance with aspects of the present disclosure. As will be seen, in various embodiments, the issuer computer 112a may receive payment card account applications directly from consumers or via a WSP.

Further, the storage device 604 may store a transaction handling application program 614 that programs the processor 600 to control the issuer computer 112a such that it is enabled to handle payment transactions, including receiving of transaction authorization request messages and generating and sending transaction authorization response messages, as typically is performed in transaction handling by a payment card account issuer.

Still further, the storage device 604 may also store a clearing application program 616. The clearing application program 616 may program the processor 600 to control the issuer computer 112a such that the issuer computer 112a engages in clearing of payment card account transactions, in a manner customarily undertaken by issuers of payment card accounts.

The storage device 604 may further store an account management program for managing users' payment card accounts, database management programs and an internal reporting application (all not separately shown), the latter of which may respond to requests from computer system administrators for reports on the activities performed by the issuer computer 112a; the storage device 604 may also store communication software, device drivers, etc.

The storage device 604 may also store one or more databases 618 required for operation of the payment network computer 1200.

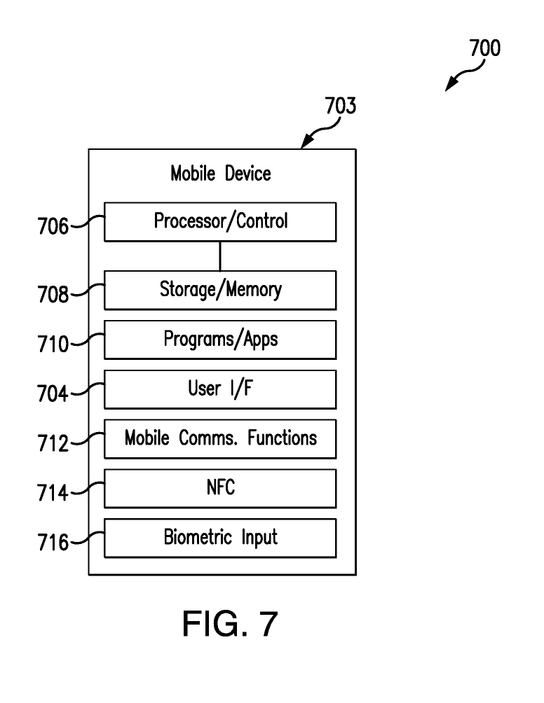

FIG. 7 is a block diagram that shows some features of a typical mobile device 700 that may in some situations function as the user device 304 shown in FIGS. 3 and 4.

The mobile device 700 may include a housing 703. In many embodiments, the front of the housing 703 is predominantly constituted by a touchscreen (not separately shown), which is a key element of the user interface 704 of the mobile device 700.

The mobile device 700 further includes a mobile processor/control circuit 706, which is contained within the housing 703. Also included in the mobile device 700 is a storage/memory device or devices (reference numeral 708). The storage/memory devices 708 are in communication with the processor/control circuit 706 and may contain program instructions to control the processor/control circuit 706 to manage and perform various functions of the mobile device 700. As is well-known, a device such as mobile device 700 may function as what is in effect a pocket-sized personal computer (assuming for example that the mobile device is a smartphone), via programming with a number of application programs, or “apps”, as well as a mobile operating system (OS). (The apps are represented at block 710 in FIG. 7, and may, along with other programs, in practice be stored in block 708, to program the processor/control circuit 706.) As is typical for mobile devices, the mobile device 700 may include mobile communications functions as represented by block 712. The mobile communications functions may include voice and data communications via a mobile communication network with which the mobile device 700 is registered.

In addition, to facilitate use as a payment-enabled device, the mobile device 700 may include short-range radio communications capabilities (block 714), including for example NFC (“near field communication”) capabilities.

Referring again to the apps 710 that program the mobile device 700, these may include a payment app and/or a wallet app. Where the mobile device 700 is to receive provisioning of a payment token, the payment app and/or the wallet app may include one or more features to facilitate receipt of the payment token.

Like many currently available smartphones, the mobile device 700 may also include a biometric input device 716 (e.g., a fingerprint/thumbprint reader). As is well known, the biometric input device may be utilized for authenticating the user of the device for the purpose of payment transactions or for other purposes.

From the foregoing discussion, it will be appreciated that the blocks depicted in FIG. 7 as components of the mobile device 700 may in effect overlap with each other, and/or there may be functional connections among the blocks which are not explicitly shown in the drawing. It may also be assumed that, like a typical smartphone, the mobile device 700 may include a rechargeable battery (not shown) that is contained within the housing 703 and that provides electrical power to the active components of the mobile device 700.

It has been posited that the mobile device 700 may be embodied as a smartphone, but this assumption is not intended to be limiting, as mobile device 700 may alternatively, in at least some cases, be constituted by a tablet computer or by other types of mobile computing devices.

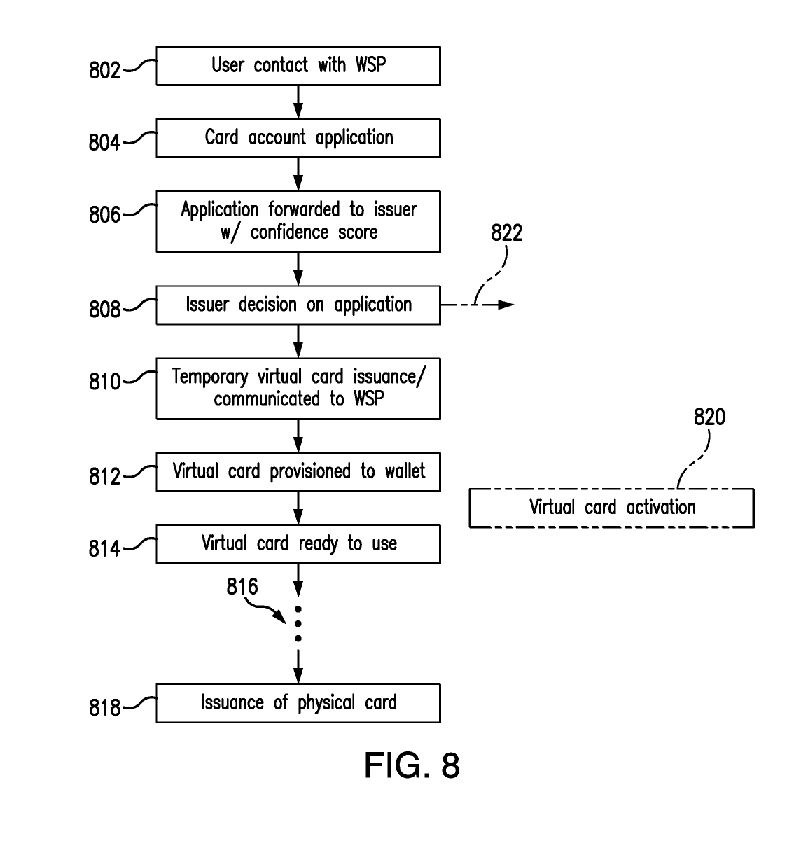

FIG. 8 is a flow chart that illustrates a process that may be performed in accordance with aspects of the present disclosure. In particular, FIG. 8 is illustrative of a process that may be performed in the arrangement depicted in FIG. 3.

At block 802 in FIG. 8, the user contacts the WSP computer 302. It is assumed that the user interacts with the website maintained by the WSP computer 302 via the user device 304. In doing so, the user may select an option to access a card account application function offered on the WSP website and may use that function to select a particular card account product (assumed in this case to be offered by the issuer that operates the issuer computer 112a shown in FIG. 3). The user may also then proceed with a card account application function (block 804). For example, the user's name and other information about the user (such as normally collected for an online payment card account application) may be automatically populated into a virtual application form from information already available about the user in the WSP computer 302 and/or the user may manually fill in required information by interacting with the virtual application form.

It is next assumed that the WSP computer 302 calculates or has on hand a confidence score that indicates the likelihood that the user is a bona fide, reliable individual suitable for receiving an extension of credit. The confidence score may be based on a number of factors, including the length of time the user has been a client of the WSP, how many payment card accounts have been previously digitized to the user's digital wallet, history of usage of the user's digital wallet, user device identification information, etc.

At block 806, the WSP computer 806 forwards the user's card account application, together with the confidence score to the issuer computer 112a.

At block 808, the issuer computer 112a may make a decision on whether to approve the payment card account application. In some embodiments, this decision may be based largely or entirely on the confidence score provided by the WSP computer 808. Approval of the application may be referred to as a positive determination on the application.

On the assumption that the issuer computer 112a approves the payment card account application, block 810 follows block 808 in FIG. 8. At block 810, the issuer computer 112a communicates to the WSP computer 302 that the payment card account application is approved, and that instant issuance of a temporary virtual card is to be implemented. As part of this process, the WSP computer 302 may issue a PAN (primary account number) for the payment card account that is being issued and may provide the PAN to the WSP computer 302.

Block 812 may follow block 810. At block 812, the WSP computer 302 may provision the virtual card to the user's digital wallet. For this to occur, the WSP computer 302 may obtain a payment token from the token service provider (FIG. 2, not shown in FIG. 3). The token service provider may, in issuing the payment token, map that token to the just issued PAN. The WSP computer 302 may provision the payment token to the user's digital wallet maintained in the WSP computer 302. In addition or alternatively, the WSP computer 302 may provision the payment token to a payment app or wallet app on the user's payment-enabled mobile device, which may be the user device 304 shown in FIG. 3. In lieu of provisioning a payment token to the user's WSP-based or mobile-device-based digital wallet—in some embodiments—the WSP computer 302 may provision the newly issued PAN to the user's digital wallet(s). With the provisioning of the token/PAN to the user's digital wallet(s), the virtual payment account card is now available for use in payment transactions by the user, as indicated at block 814.

In some embodiments, the processing in steps 806-814 may be accomplished within a matter of a few seconds and in any event within 5, 10 or 15 minutes after submission of the card account application at 804. Such a quickly accomplished virtual fulfillment of the card account application may be considered to be an instant issuance of the virtual payment account card. With the instant issuance process as described herein, the lapse of time between submission of the payment card account application and access by the user to the resulting payment card account may be essentially reduced to a negligible period of time. As a result, the user need not experience the lapse of several days or longer that typically has occurred with conventional payment card issuance systems. So, too, the issuer of the virtual payment card, as referred to in connection with this FIG. 8, may begin to receive transactions and thus generate revenue on the new account essentially immediately, and without the usual delay in starting use of the account due to the conventional lag time between approval of the payment card account application and receipt by the user of the physical payment account card.

Referring again to FIG. 8, and following block 814, there may be a lapse of time (indicated by ellipsis 816), and then following the lapse of time, block 818 may occur. At block 818, the account issuer may issue and send to the user the corresponding physical payment account card for the newly issued PAN/payment card account. The lapse of time between 814 and 818 may be the typical period of a number of days or a week or so, as in conventional card issuance practices.

For security reasons, a virtual card activation process (phantom block 820 may be associated with provisioning the virtual card to the user's digital wallet(s)/making the virtual card available for use. The activation process may include a suitable interaction between the user (via his/her user device 304, for example) and the account issuer. Device authentication of the user via biometric input may be part of the activation interaction.

Referring again to block 808, in the event the payment card account application is declined, a suitable branch of the process may occur to indicate this situation, as schematically represented at dashed arrow 822.

In some embodiments, both the WSP and the token service provider may be under common operation, e.g., by the operator of a payment network, such as Mastercard International Incorporated, the assignee hereof.

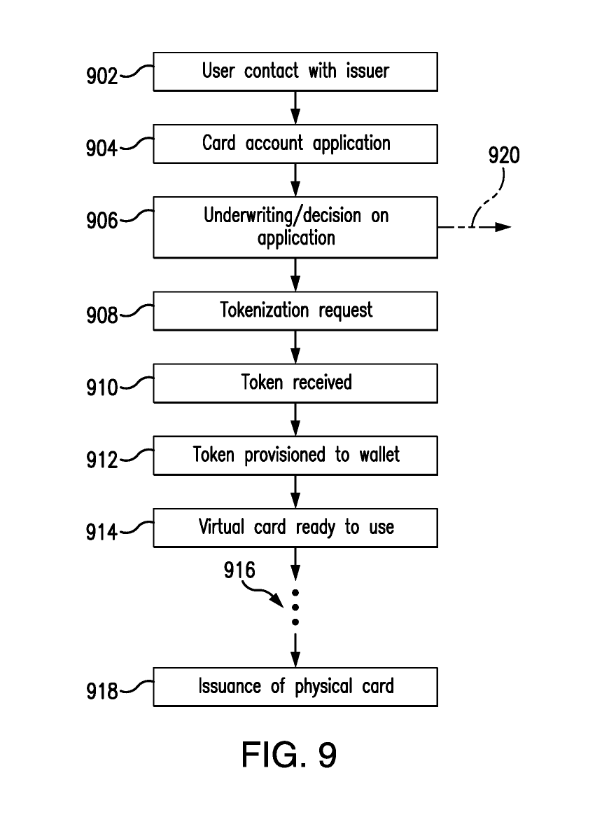

FIG. 9 is a flow chart that illustrates a process that may be performed in accordance with aspects of the present disclosure. In particular, FIG. 9 is illustrative of a process that may be performed in the arrangement depicted in FIG. 4.

At block 902 in FIG. 9, the user contacts the issuer computer 112b. It is assumed that the user interacts with a website maintained by the issuer computer 112b via the user device 304. In doing so, the user may select an option to access a card account application function offered on the issuer website and may use that function to select a particular card account product. The user may also then proceed with a card account application function (block 904). For example, the user may manually fill in required information (e.g., name, contact information, Social Security No., etc.) by interacting with the virtual application form.

Block 906 may follow block 904 in the process of FIG. 9. At block 906, the issuer computer 112b may perform a conventional underwriting process and decide on the basis of that process whether to approve the payment card account application.

On the assumption that the issuer computer 112b approves (i.e., makes a positive determination on) the payment card account application, block 908 follows block 906 in FIG. 9. It is assumed that upon approval of the payment card account application, the issuer computer 112b has issued a new PAN that represents the applied-for and now issued payment card account. At block 908 the issuer computer 112b may be in communication with the token service provider 204 to obtain tokenization of the just-issued PAN. This may occur according to known principles for tokenization practices, as are familiar to those who are skilled in the art. At block 910, the issuer computer 112b may receive the resulting payment token from the token services provider 204.

Block 912 may follow block 910 in the process of FIG. 9. At block 912, the issuer computer may provision the payment token to the user's digital wallet, as maintained at the user's WSP 302a (shown in phantom in FIG. 4). In addition or alternatively, the issuer computer 112b may provision the payment token to a payment app or wallet app on the user's payment-enabled mobile device, which may be the user device 304 shown in FIG. 4. In some embodiments, the provisioning of the token to the user's payment-enabled mobile device may be handled by a service retained for that purpose by the account issuer.

In alternative embodiments, the issuer server 112b may provision the newly issued PAN to the user's digital wallet(s), in lieu of obtaining tokenization of the PAN.

With the provisioning of the payment token (or PAN) to the user's digital wallet at 912, the newly issued payment card account is now available for use in payment transactions by the user, as indicated at block 914.

In some embodiments, the processing of blocks 906-912 may proceed very rapidly, i.e., “instantly”, as described above in connection with blocks 806-814 in FIG. 8. This provides the same advantages to the user and the issuer as described above in connection with the embodiment of FIG. 8.

Referring again to FIG. 9, and following block 914, there may be a lapse of time (indicated by ellipsis 916), and then following the lapse of time, block 918 may occur. At block 918, the account issuer may issue and send to the user the corresponding physical payment account card for the newly issued PAN/payment card account. The lapse of time between 914 and 918 may be the typical period of a number of days or a week or so, as in conventional card issuance practices.

Referring again to block 906, in the event the payment card account application is declined, a suitable branch of the process may occur to indicate this situation, as schematically represented at dashed arrow 920.

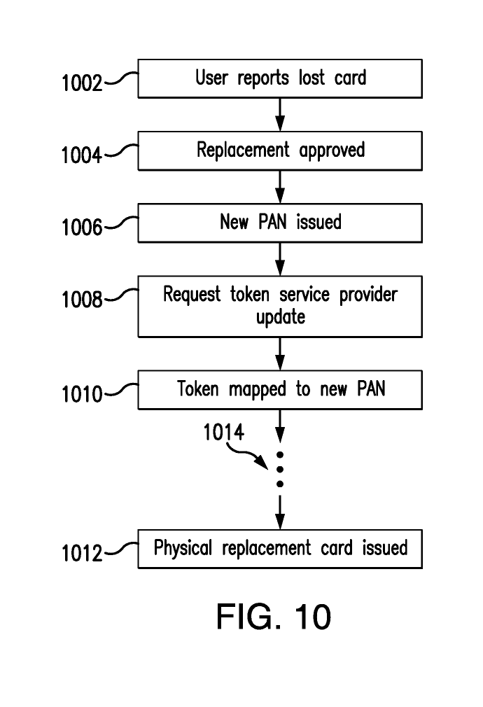

FIG. 10 is a flow chart that illustrates a process that may be performed in accordance with aspects of the present disclosure. In particular, FIG. 10 is illustrative of a process that may be performed in the event that the user has lost (or had stolen) his/her payment account card.

At block 1002 in FIG. 10, the user/account holder reports to the account issuer that her/his payment account card has been lost. This may occur in a typical manner, such as by the user telephoning the account issuer via a designated toll-free telephone number. It will be appreciated that upon receiving the report of the lost card, the account issuer may deactivate the PAN which identifies the user's payment card account.

Block 1004 represents a determination by the account issuer that the circumstances are such that a replacement card should be issued.

Block 1006 represents issuance of a new PAN for the user's payment card account. This of course is done by the account issuer.

Block 1008 may follow block 1006 in FIG. 10. At block 1008, the account issuer may request that the token service provider update its records to reflect the issuance of the new PAN.

Block 1010 may follow block 1008. At block 1010, the token service provider may map a payment token (previously provisioned to the account holder's digital wallet) to the new PAN. As soon as this has taken place (which may be in a matter of minutes—say 15 to 30 minutes—or less after the lost card report), the user may be able to use the token in his/her digital wallet, even though the replacement card has not yet been issued. The issuance of the physical replacement card may occur a few days later at block 1012, after the delay as indicated by the ellipsis 1014.

With the process of FIG. 10, there may be essentially instant virtual replacement of a lost payment account card, so that the user is free to use the virtual card with little or no interruption while waiting for the physical replacement payment account card to be issued. By the same notion, the account issuer may continue to have transactions occur by use of the payment card account, even during the interim period of issuance of the replacement physical card.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving, from a consumer, an application for a payment card account;
making a positive determination on the received application; and
in response to the positive determination, making a virtual payment card account instantly available for use by the consumer in a digital wallet accessible to the consumer.

2. The method of claim 1, wherein the digital wallet is associated with a wallet application program running on the consumer's mobile device.

3. The method of claim 1, wherein the digital wallet is stored in a database partition on a server computer operated by a wallet service provider.

4. The method of claim 1, wherein the application is received at a wallet service provider.

5. The method of claim 4, wherein the wallet service provider forwards the application to an account issuer.

6. The method of claim 5, wherein the wallet service provider forwards, to the account issuer, together with the application, a confidence score pertaining to the consumer.

7. The method of claim 1, wherein the application is received at an account issuer.

8. The method of claim 1, wherein the virtual payment card account is tokenized.

9. The method of claim 1, further comprising:
receiving an activation request from the consumer with respect to the virtual payment card account.

10. A method comprising:
receiving, from a consumer, a notification that the consumer's payment account card has been lost;
deactivating a primary account number (PAN) associated with the lost payment account card;
assigning a new PAN to the consumer;
mapping a token to the new PAN, the token having been held in the consumer's digital wallet prior to said receiving step;
allowing use of the token via the consumer's digital wallet after the receiving step and prior to issuance of a replacement physical payment account card to the consumer.

11. The method of claim 10, wherein the digital wallet is associated with a wallet application program running on the consumer's mobile device.

12. The method of claim 10, wherein the digital wallet is stored in a database partition on a server computer operated by a wallet service provider.

13. The method of claim 10, wherein the receiving step is performed by an issuer of a payment card account associated with the lost payment account card.

14. An apparatus comprising:
a processor; and
a memory in communication with the processor, the memory storing program instructions, the processor operative with the program instructions to perform functions as follows:
receiving, from a consumer, an application for a payment card account;
making a positive determination on the received application; and
in response to the positive determination, making a virtual payment card account instantly available for use by the consumer in a digital wallet accessible to the consumer.

15. The apparatus of claim 14, wherein the digital wallet is associated with a wallet application program running on the consumer's mobile device.

16. The apparatus of claim 14, wherein the digital wallet is stored in a database partition on a server computer operated by a wallet service provider.

17. The apparatus of claim 14, wherein the application is received at a wallet service provider.

18. The apparatus of claim 17, wherein the wallet service provider forwards the application to an account issuer.

19. The apparatus of claim 18, wherein the wallet service provider forwards, to the account issuer, together with the application, a confidence score pertaining to the consumer.

20. The apparatus of claim 14, wherein the application is received at an account issuer.
